(19) United States
(12) Patent Application Publication
(10) Pub. No.: US 2007/0283801 A1
(43) Pub. Date: Dec. 13, 2007

(54) Armor apparatus and method

(75) Inventor: Massimo Alexandro Gallo, Dallas, TX (US)

Correspondence Address: HAYNES AND BOONE, LLP, 901 MAIN STREET, SUITE 3100, DALLAS, TX, 75202, US

(73) Assignee: Armorsmith Company, Dallas, TX (US)

(21) Appl. No.: 11/450,221

(22) Filed: Jun. 9, 2006

(51) Int. Cl. B32B 27/32; B32B 27/20; B32B 9/00; B32B 5/16; B32B 7/02; B32B 19/00; B32B 27/04; F41H 5/02

(52) U.S. Cl. 89/36.02; 428/323; 428/212; 428/220; 977/750; 977/752; 428/702; 428/412; 442/6; 442/19; 442/20

(57) ABSTRACT

An armor apparatus and method according to which a transparent armor laminate is provided.

### BACKGROUND

The present disclosure relates in general to armor and in particular to a transparent armor apparatus and method according to which a transparent armor laminate is provided.

### BRIEF DESCRIPTION OF THE DRAWINGS

FIG. 1 is a perspective view of a transparent armor apparatus according to an embodiment, which is in the form of a transparent face shield and is coupled to a helmet.

FIG. 2 is a perspective view of the transparent face shield of FIG. 1.

FIG. 3 is a sectional view of the transparent face shield of FIGS. 1 and 2, depicting a portion of the section taken along line 3-3 of FIG. 2.

FIG. 4 is a perspective view of a transparent armor apparatus according to another embodiment, which is in the form of a vehicular window.

### DETAILED DESCRIPTION

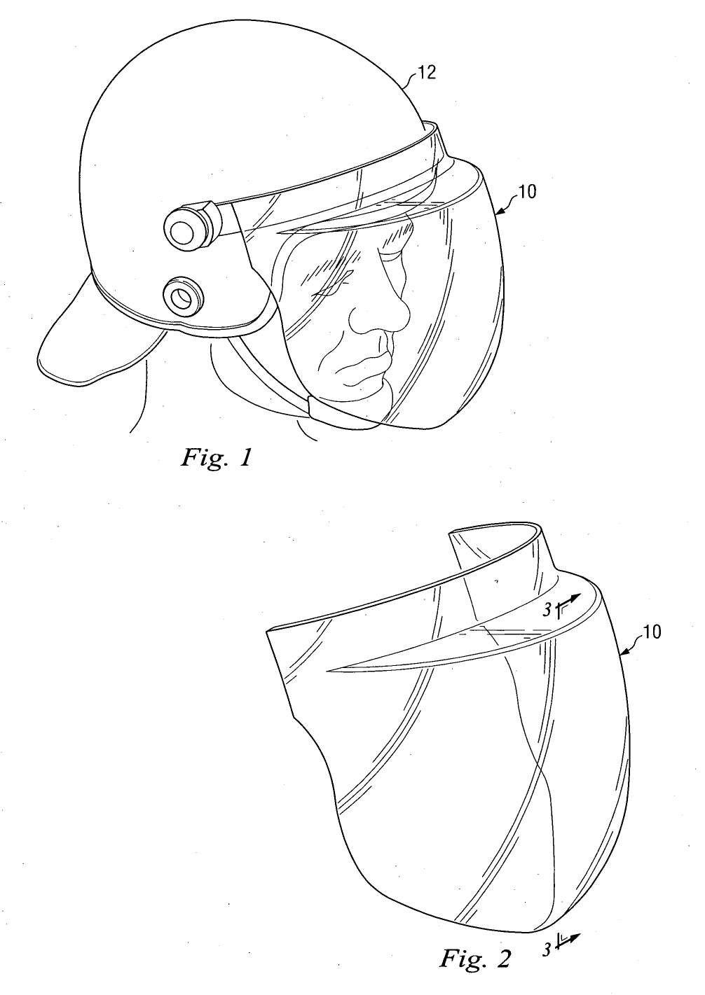

Referring to FIGS. 1 and 2, an exemplary embodiment of a generally transparent armor apparatus, in the form of a generally transparent face shield, is referred to in general by the reference numeral 10 and is coupled to an open-faced helmet 12. The face shield 10 is adapted to shield and protect the face and head of a wearer of the helmet 12, in a manner and under conditions to be described.

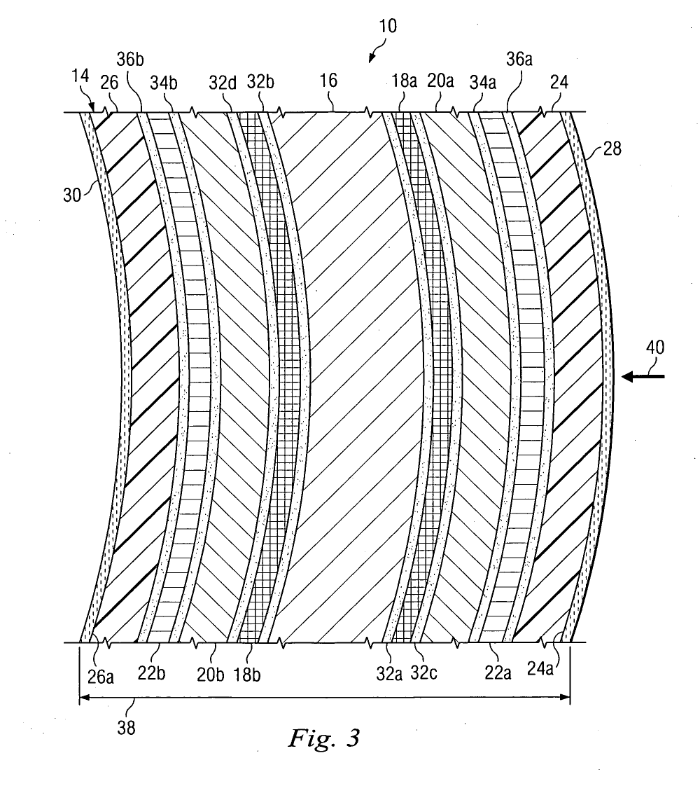

Referring to FIG. 3, with continuing reference to FIGS. 1 and 2, the face shield 10 is a lightweight composite, comprising a transparent armor laminate 14, which includes a center core layer 16 comprising cubic crystal structural spinel (MgAl₂O₄). The core layer 16 comprises a relatively high modulus of elasticity, a high strength, optical clarity and a thickness ranging from about 1/16 in to about ½ in. The core layer 16 is manufactured using spinel powder and a sintering process.

Layers of wire mesh 18a and 18b are coupled to the core layer 16 so that the core layer 16 is disposed between the wire-mesh layers 18a and 18b. Each of the wire-mesh layers 18a and 18b comprises a plurality of wires arranged in a diamond-crossing pattern. The wire in each of the wire-mesh layers 18a and 18b comprises metal strengthened with carbon multi-walled nanotubes (MWNTs), aramid fiber strengthened with carbon MWNTs, or high-modulus-polyethylene (HMPE) fiber strengthened with carbon MWNTs. The thickness of the wire in each of the wire-mesh layers 18a and 18b is less than 800 denier and is minimized in order to generally prevent any optical obstruction.

Intermediate layers 20a and 20b are coupled to the wire-mesh layers 18a and 18b, respectively, so that the core layer 16 is disposed between the intermediate layers 20a and 20b, the wire-mesh layer 18a is disposed between the core layer 16 and the intermediate layer 20a, and the wire-mesh layer 18b is disposed between the core layer 16 and the intermediate layer 20b.

Each of the intermediate layers 20a and 20b comprises a plurality of sub-layers, or interlayer sheets, of carbon MWNTs. The carbon MWNTs in the intermediate layers 20a and 20b are highly oriented and free-standing, and are produced by a solid-state process. Moreover, each of the intermediate layers 22a and 22b has a modulus of elasticity that is less than the modulus of elasticity of the core layer 16.

Each interlayer sheet of carbon MWNTs in the intermediate layers 20a and 20b comprises a thickness of 1/16 in. To form each of the intermediate layers 20a and 20b, the respective interlayer sheets of carbon MWNTs are assembled into biaxially-reinforced sheet arrays.

Light filters 22a and 22b are coupled to the intermediate layers 20a and 20b, respectively, so that the intermediate layer 20a is disposed between the wire-mesh layer 18a and the light filter 22a, and the intermediate layer 20b is disposed between the wire-mesh layer 18b and the light filter 22b. Each of the light filters 22a and 22b comprises a light-threat-resistant plastic material that is suitable for use as a laser-protective filter, and that is adapted to provide light-threat protection against laser, ultraviolet, infrared, glint and reflected light. In an exemplary embodiment, each of the light filters 22a and 22b is adapted to prevent multiple laser wave-lengths from temporarily or permanently blinding the wearer of the helmet 12. In several exemplary embodiments, each of the light filters 22a and 22b comprises one or more dielectric stacks, dielectric coatings, holograms, organic absorber dyes, films, polycarbonates, rugates, non-linear optical materials and/or any combination thereof.

An outer layer 24 comprising an outer side 24a is coupled to the light filter 22a so that the light filter 22a is disposed between the intermediate layer 20a and the outer layer 24. The outer layer 24 comprises a high-impact-resistant polycarbonate laminate such as, for example, Lexan®, and has a relatively low modulus of elasticity and a relatively low density. The modulus of elasticity of the outer layer 24 is less than the modulus of elasticity of the intermediate layer 20a, which, as noted above, is less than the modulus of elasticity of the core layer 16. The outer layer 24 comprises a thickness of 1/16 in.

A backing layer 26 comprising a backing side 26a is coupled to the light filter 22b so that the light filter 22b is disposed between the intermediate layer 20b and the backing layer 26. The backing layer 26 comprises a high-impact-resistant polycarbonate laminate such as, for example, Lexan®, and has a relatively low modulus of elasticity and a relatively low density. The modulus of elasticity of the backing layer 26 is less than the modulus of elasticity of the intermediate layer 20b, which, as noted above, is less than the modulus of elasticity of the core layer 16. The backing layer 26 comprises a thickness of 1/16 in.

A protective coating layer 28 is applied to the outer side 24a of the outer layer 24, and is both abrasion resistant and chemical resistant, thereby facilitating the optical clarity of the face shield 10. The coating 28 comprises either a silicone-based coating or a melamine-based coating and is applied to the outer layer 24 by flow coating.

A protective coating layer 30 is applied to the backing side 26a of the backing layer 26, and is both abrasion resistant and chemical resistant, thereby facilitating the optical clarity of the face shield 10. The coating 30 comprises either a silicone-based coating or a melamine-based coating and is applied to the backing layer 26 by flow coating.

Coatings, deposits and/or layers of transparent, bonding adhesive resin 32a and 32b securely bond the wire-mesh layers 18a and 18b, respectively, to the core layer 16. Similarly, coatings, deposits and/or layers of resin 32c and 32d securely bond the intermediate layers 20a and 20b, respectively, to the wire-mesh layers 18a and 18b, respectively. The resin layers 32a, 32b, 32c and 32d are applied in one or more conventional manners and are subsequently cured at elevated temperatures and pressures using an autoclave or cast-laminating process. As a result of using an autoclave or cast-laminating process, the resin layers 32a and 32c effectively couple the intermediate layer 20a to the core layer 16, and the resin layers 32b and 32d effectively couple the intermediate layer 20b to the core layer 16. The autoclave or cast-laminating process will vary according to the types of adhesive resin used for the resin layers 32a, 32b, 32c and 32d.

Coatings, deposits and/or layers of transparent, bonding adhesive resin 34a and 34b securely bond the light filters 22a and 22b, respectively, to the intermediate layers 20a and 20b, respectively. Similarly, coatings, deposits and/or layers of transparent, bonding adhesive resin 36a and 36b securely bond the outer layer 24 and the backing layer 26, respectively, to the light filters 22a and 22b, respectively. The resin layers 34a, 34b, 36a and 36b are applied in one or more conventional manners and are subsequently cured at elevated temperatures and pressures. As a result of subjecting the core layer 16, the wire-mesh layers 18a and 18b, the intermediate layers 20a and 20b, the light filters 22a and 22b, the outer layer 24 and the backing layer 26 to sufficient amounts of heat and pressure, the resin layers 34a and 36a effectively couple the outer layer 24 to the intermediate layer 20a and thus to the core layer 16, and the resin layers 34b and 36b effectively couple the backing layer 26 to the intermediate layer 20b and thus to the core layer 16. The amounts of heat and pressure will vary according to the types of adhesive resin used for the resin layers 34a, 34b, 36a and 36b.

As a result of the above-described construction, the laminate 14, and thus the face shield 10, is lightweight and relatively thin, comprising a thickness 38 ranging from about 1/16 in to about ½ in, and comprising an a real density not exceeding about 3.0 lb/ft². As a result, the face shield 10 is permitted to comprise the rigid, complex and curved shape shown in FIGS. 1 and 2, which includes, for example, curvatures of varying degrees. As a result of its lightweight construction and its ability to be formed into a complex, curved shape, the face shield 10 is shaped to conform to the general shape of the face of a wearer of the helmet 12, and thus is well-suited to protect the face and head of the wearer of the helmet 12, as will be described in further detail below.

In several exemplary embodiments, the thickness 38 of the laminate 14 may be varied in response to the types of expected threats during the use of the face shield 10. For example, the thickness 38 ranges from about ⅕ in (or about 5 mm) to about ½ in (or about 12.7 mm) for defeating one or more threats that are generally at least as great as, or greater than, the threat level of National Institute of Justice (NIJ) Ballistic Standard III-A, which is equivalent to the threat level of, or an impact caused by, a 9-mm bullet traveling at 1425 ft/sec. For another example, the thickness 38 is about ¼ in (or about 6.35 mm) for defeating multiple hits, each of which are generally at least as great as, or greater than, the threat level of NIJ Ballistic Standard III-A.

In operation, the laminate 14, and thus the face shield 10, protects the face and head of the wearer of the helmet 12 by providing protection against, and defeating, a wide variety of high-velocity and low-velocity impacts or threats, which may be in the form of, for example, a single-hit projectile or multi-hit projectiles; by providing abrasion resistance; by providing chemical resistance; and by providing protection against light threats such as, for example, laser threats. Moreover, the face shield 10 permits the wearer of the helmet 12 to see through the face shield 10 easily and clearly, as a result of the optical clarity and/or general transparency of each of the layers in the laminate 14.

As noted above, the laminate 14, and thus the face shield 10, provides protection against, and defeats, a wide variety of single and multiple-projectile impacts or hits having either relatively high or relatively low velocities.

For example, the laminate 14, and thus the face shield 10, operates to provide protection against an impact or threat that is at least as great as, or greater than, the threat level of NIJ Ballistic Standard III-A, which is equivalent to the threat of, or an impact caused by, a 9-mm bullet traveling at 1425 ft/sec. When such a projectile, hereinafter referred to as a “III-A projectile” and which is equivalent to a 9-mm bullet traveling at 1425 ft/sec, impacts the face shield 10 in the direction indicated by an arrow 40 in FIG. 3, the III-A projectile begins to mushroom as it penetrates through the coating 28, the outer layer 24, the light filter 22a, the intermediate layer 20a and the wire-mesh layer 18a.

The degree of mushrooming of the III-A projectile increases as the III-A projectile penetrates further into the laminate 14 in the direction of the arrow 40. The outer layer 24, the intermediate layer 20a and the wire-mesh layer 18a promote the mushrooming of the III-A projectile, and may flex inwardly before, during and/or after the impact and penetration of the III-A projectile. Moreover, the outer layer 24, the intermediate layer 20a and the wire-mesh layer 18a resist the travel of the III-A projectile.

When the III-A projectile impacts the core layer 16, the III-A projectile mushrooms further and is defeated by the core layer 16, that is, the III-A projectile does not penetrate past the core layer 16. The relatively high modulus of elasticity of the material of the core layer 16 appreciably facilitates the defeat of the III-A projectile.

The wire-mesh layer 18b facilitates the absorption and distribution of shock waves generated in the face shield 10 in response to the impact, partial penetration and subsequent defeat of the III-A projectile. Shock waves generated by the III-A projectile are absorbed and distributed throughout the wire-mesh layer 18b.

The intermediate layer 20b also facilitates the absorption and distribution of shock waves generated in the face shield 10 in response to the impact, penetration and defeat of the III-A projectile. The carbon MWNTs in the intermediate layer 20b appreciably enhance the ability of the face shield 10 to absorb and distribute shock waves.

Moreover, the intermediate layer 20b provides the wearer of the helmet 12 with thermal protection against any heat present in the face shield 10, which may be generated by, for example, the impact, partial penetration and defeat of the III-A projectile. The carbon MWNTs in the intermediate layer 20b generally resist any heat transfer through the intermediate layer 20b, thereby generally resisting any heat transfer from the face shield 10 to the face and/or head of the wearer of the helmet 12. Moreover, the carbon MWNTs in the intermediate layer 20b provide microwave absorption and electrical conductivity capabilities.

The backing layer 26 provides protection from spalling. More particularly, the core layer 16 undergoes spalling, that is, chipping, fragmenting and/or cracking, in response to the impact of the III-A projectile against the core layer 16 and the subsequent defeat of the III-A projectile by the core layer 16. The spall, that is, the chips, fragments and/or debris produced as a result of the spalling of the core layer 16, which may comprise the material of the core layer 16, the material of the III-A projectile and/or other material, impacts and/or penetrates one or more portions of the wire-mesh layer 18b and/or the intermediate layer 20b. The backing layer 26 catches any spall that does indeed penetrate both the wire-mesh layer 18b and the intermediate 20b, thereby defeating the spall and preventing the spall from striking the wearer of the helmet 12. The relatively low modulus of elasticity of the backing layer 26 appreciably facilitates the defeat of the spall by the backing layer 26 and thus the prevention of any spall penetration through the backing layer 26.

The core layer 16, the wire-mesh layer 18b, the intermediate layer 20b and/or the backing layer 26 may flex inwardly, in response to the above-described defeat of the III-A projectile, shock-wave absorption and distribution, and/or catching of any spall.

The modulus-of-elasticity gradient within the laminate 14, that is, the decrease in the modulus of elasticity from the core layer 16 to the intermediate layer 20b, and the decrease in the modulus of elasticity from the intermediate layer 20b to the backing layer 26, facilitates the ability of the laminate 14 to defeat the III-A projectile at the core layer 16, thereby preventing the III-A projectile from penetrating past the core layer 16, and further to defeat or catch any resulting spall at the backing layer 26, thereby preventing any spall from penetrating past the backing layer 26.

During the use of the face shield 10, the light filters 22a and 22b provide protection from any light threats such as, for example, any laser, ultraviolet, infrared, glint and/or reflected light radiation.

During the use of the face shield 10, the outer layer 24 provides abrasion resistance, and the coatings 28 and 30 provide both abrasion resistance and chemical resistance.

If the III-A projectile approaches and contacts the outer layer 24 in a direction other than the direction indicated by the arrow 40, then the operation of the face shield 10 is substantially similar to the above-described operation of the face shield 10. Moreover, if the III-A projectile approaches and contacts the backing layer 26, from any direction and for whatever reason, then the operation of the face shield 10 is substantially similar to the above-described operation of the face shield 10, except that backing layer 26, the light filter 22b, the intermediate layer 20b and the wire mesh 18b function in a manner substantially identical to the above-described manner of operation of the outer layer 24, the light filter 22a, the intermediate layer 20a and the wire mesh 18a, respectively, and vice versa.

In addition to providing protection against a projectile threat that is at least as great as, or greater than, the threat level of NIJ Ballistic Standard III-A, as described above, the face shield 10 operates to provide protection against a wide variety of other high-velocity and/or low-velocity impacts or threats such as, for example, projectile threats having levels that are relatively less than the threat level of, or an impact caused by, NIJ Ballistic Standard III-A.

For another example, if a relatively low-level threat such as a low-velocity projectile strikes the face shield 10, the outer layer 24 deflects the low-velocity projectile off of the face shield 10.

For another example, if the face shield 10 undergoes a cut or blunt attack, the face shield 10 withstands and defeats the attack. In an exemplary embodiment, at least the outer layer 24 flexes inwardly and/or is deformed in response to the cut or blunt attack. In an exemplary embodiment, the outer layer 24 deflects the cut or blunt attack. Moreover, the wire-mesh layers 18a and/or 18b, and the intermediate layers 20a and/or 20b, absorb and distribute shock-wave forces generated in response to the attack. Also, the outer layer 24, the core layer 16 and the backing layer 26 aid in the distribution and absorption of the shock-wave forces generated in response to the attack.

For another example, the laminate 14, and thus the face shield 10, operates to provide protection against a blast threat such as, for example, an explosion or blast caused by an improvised explosive device (IED), a grenade and/or a rocket-propelled grenade (RPG). More particularly, the laminate 14 operates to provide protection against bomb blast waves and overpressure, that is, the transient air pressure-such as, for example, the shock wave from the explosion of a blast threat-that is greater than the surrounding atmospheric pressure. Further, the laminate 14 operates to provide protection against fragmentation, that is, the breaking and multi-directional scattering of the pieces of a projectile, bomb, grenade and/or solid mass generated as a result of a blast threat. Still further, the laminate 14 operates to provide protection against light flash, which is the light and infrared emissions generated as a result of a blast threat and which can cause severe burns to a human positioned near the source of the blast threat. Still further, the laminate 14 provides protection against any heat or flame generated as a result of a blast threat.

When the face shield 10 undergoes a blast threat, the laminate 14 reduces blast pressure, that is, the intensity of the blast waves, while preserving relatively little of the explosive energy as momentum, and provides shock attenuation and blast mitigation throughout one or more of the above-described layers of the laminate 14. The modulus-of-elasticity gradient within the laminate 14, that is, the decrease in the modulus of elasticity from the core layer 16 to the intermediate layer 20b, and the decrease in the modulus of elasticity from the intermediate layer 20b to the backing layer 26, facilitates the ability of the laminate 14 to mitigate the overpressure and fragmentation caused by the blast threat, thereby rapidly reducing shock pressures, in relation to the distance of the laminate 14 from the source of the blast threat. In several exemplary embodiments, the above-described layers of the laminate 14 interact to flex and elastically deform, from the outer layer 26 to the backing layer 24, in order to absorb and mitigate effects caused by a blast threat including, but not limited to, overpressure, fragmentation and/or any heat or flame. In several exemplary embodiments, the laminate 14 provides protection against a wide variety of blast threats having a wide variety of parameters.

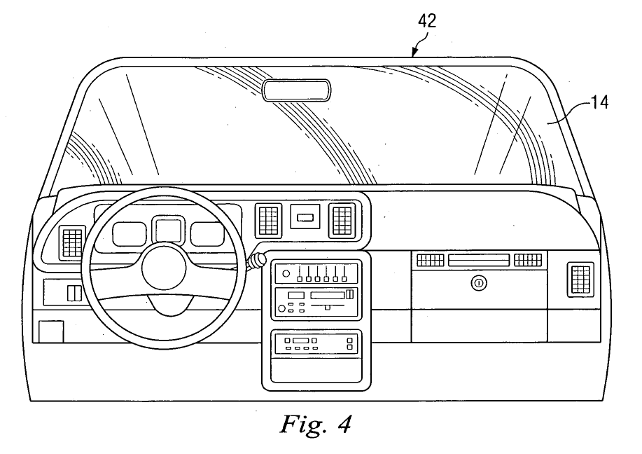

Referring to FIG. 4, an exemplary embodiment of a generally transparent armor apparatus, in the form of a vehicular window, is referred to in general by the reference numeral 42. The window 42 comprises the above-described laminate 14, which is shaped to form the complex and curved shape of the window 42. In several exemplary embodiments, the window 42 may be integrated with, and/or coupled to, a wide variety of vehicular systems and/or components thereof such as, for example, windows for a wide variety of automobiles and personnel carriers, and windshields for automobiles, speedboats and motorcycles.

The operation of the window 42 is substantially identical to the operation of the face shield 10 of FIGS. 1-3 and therefore the operation of the window 42 will not be described in detail.

In accordance with the foregoing, the laminate 14, and thus the face shield 10 or window 42, provides protection against, and defeats, threats that include, but are not limited to, ballistic projectiles of calibers described by one or more of the North Atlantic Treaty Organization (NATO) standards of threats; ballistic projectiles of calibers described by one or more of the NIJ standards of threats including NIJ Standard III-A; ballistic projectiles that are generated by, and/or are fired from, small-arms weapons and high-powered rifles; attacks from professional and improvised explosive devices (IEDs); artillery shells; land mines; grenades; missiles having explosive warheads and fired from, for example, land, air and sea vehicles; blast effects including fragmentation, shrapnel, heat threats, overpressure, acceleration force and/or deceleration force; blunt-weapon attacks; hand-to-hand combat attacks; cutting-weapon attacks; stabbing-weapon attacks; accidental falls and impacts; and shock-wave forces and/or trauma.

### Variations

Variations may be made in the foregoing without departing from the scope of the disclosure. Examples of such variations include, but are not limited to, the variations described below.

In an exemplary embodiment, in addition to, or instead of cubic crystal structural spinel (MgAl₂O₄), the core layer 16 may comprise any type of transparent ceramic material, and/or any combination of transparent ceramic materials. In an exemplary embodiment, the material of the core layer 16 may be reinforced with one or more nanomaterials such as, for example, inorganic and/or organic single-walled nanotubes (SWNTs), inorganic and/or organic multi-walled nanotubes (MWNTs), and/or any combination thereof. In an exemplary embodiment, the core layer may be comprised entirely of nanomaterials such as, for example, inorganic and/or organic SWNTs, inorganic and/or organic MWNTs, and/or any combination thereof.

In several exemplary embodiments, the thickness of the core layer 16 may be decreased to less than 1/16 in or may be increased to greater than ½ in.

In several exemplary embodiments, in addition to, or instead of a diamond-crossing pattern, each of the wire-mesh layers 18a and 18b may be arranged in a wide variety of crossing patterns, non-crossing patterns and/or any combination thereof.

In several exemplary embodiments, in addition to, or instead of metal strengthened with carbon multi-walled nanotubes (MWNTs), aramid fiber strengthened with carbon MWNTs, or high-modulus-polyethylene (HMPE) fiber strengthened with carbon MWNTs, the wire in each of the wire-mesh layers 18a and 18b may comprise a wide variety of high-modulus, lightweight materials. In an exemplary embodiment, the wire in each of the wire-mesh layers 18a and 18b may comprise metal, aramid fiber, HMPE fiber and/or any combination thereof. In an exemplary embodiment, the material of which the wire in each of the wire-mesh layers 18a and 18b is comprised may be strengthened with inorganic and/or organic SWNTs, inorganic and/or organic MWNTs, and/or any combination thereof. In an exemplary embodiment, the wire in each of the wire-mesh layers 18a and 18b may be comprised entirely of nanotubes, including inorganic and/or organic SWNTs, inorganic and/or organic MWNTs, and/or any combination thereof.

In several exemplary embodiments, in addition to, or instead of carbon MWNTs, each interlayer sheet in the intermediate layers 20a and 20b may comprise a wide variety of nanotubes including, for example, inorganic and/or organic SWNTs, inorganic and/or organic MWNTs, carbon SWNTs, and/or any combination thereof.

In several exemplary embodiments, in addition to, or instead of assembling the interlayer sheets of carbon MWNTs into biaxially-reinforced sheet arrays to form the intermediate layers 20a and 20b, the intermediate layers 20a and 20b may be formed using a variety of other methods or combinations thereof.

In several exemplary embodiments, instead of comprising a thickness of 1/16 in, each interlayer sheet in the intermediate layers 20a and 20b may comprise a thickness ranging from 50 nanometers to ⅛ in.

In several exemplary embodiments, one or more antennas may be integrated within the intermediate layers 20a and/or 20b. As a result, the face shield 10 and/or the window 42 may operate as an antenna, with signals such as, for example, communication signals, being sent and received by the one or more antennas integrated within the intermediate layers 20a and 20b. Moreover, in several exemplary embodiments, one or more sensors may be integrated within the intermediate layers 20a and 20b so that the face shield 10 and/or the window 42 may operate to gather data such as, for example, temperature data. The relatively low electrical noise and relatively low temperature coefficient of resistivity associated with the interlayer sheets in the intermediate layers 20a and 20b permit electronic applications such as, for example, antenna applications and structural, chemical, light and bio sensor applications, to be carried out within the intermediate layers 20a and/or 20b.

In an exemplary embodiment, to integrate one or more antennas, and/or one or more sensors, within the intermediate layer 20a or 20b, the as-drawn interlayer sheets of MWNTs are contacted to ordinary adhesives such as, for example, adhesive tapes, to make optically transparent adhesive applique, which can be used to provide, for example, electrical heating and/or microwave absorption. More particularly, at least one of the interlayer sheets of MWNTs in the intermediate layer 20a or 20b is laminated between an adhesive tape and a contacted plastic, metal or ceramic surface. Due to MWNT sheet porosity, the peel strength is largely maintained when an undensified MWNT sheet is laminated between an adhesive tape and a contacted plastic, metal or ceramic surface.

In an exemplary embodiment, to integrate or more antennas, and/or one or more sensors, within the intermediate layer 20a or 20b, microwave-based welding is carried out to couple at least one interlayer sheet of MWNTs in the intermediate layer 20a or 20b to one or more antennas or sensors. The MWNT sheet provides a strong, uniform and transparent interface in which nanotube orientation and sheet electrical conductivity are little changed. The combination of high transparency and ultrahigh thermal stability of the MWNT sheet facilitates the microwave-based welding, and the microwave heating associated therewith, during the coupling of the MWNT sheet to the one or more antennas or sensors.

In an exemplary embodiment, to integrate one or more antennas, and/or one or more sensors, within the intermediate layer 20a or 20b, at least one of the interlayer sheets of MWNTs in the intermediate layer 20a or 20b is sandwiched between a plastic layer and a ceramic layer and the sheet of MWNTs is heated during polymer and ceramic welding.

In several exemplary embodiments, in addition to, or instead of a light-threat-resistant plastic material, the light filters 22a and 22b may each comprise a wide variety of materials, or combinations thereof, that are suitable for use as laser-protective filters.

In several exemplary embodiments, in addition to, or instead of using the light filters 22a and/or 22b, materials and/or sub-layers suitable for use as light filters may be included in the core layer 16, the wire mesh layers 18a and/or 18b, the intermediate layers 20a and/or 20b, the outer layer 24, the backing layer 26, the resin layers 32a, 32b, 32c, 32d, 34a, 34b, 36a and/or 36b, and/or any combination thereof. For example, the core layer 16, the wire mesh layers 18a and/or 18b, the intermediate layers 20a and/or 20b, the outer layer 24, the backing layer 26, and/or the resin layers 32a, 32b, 32c, 32d, 34a, 34b, 36a and/or 36b may comprise one or more dielectric stacks, dielectric coatings, holograms, organic absorber dyes, films, polycarbonates, rugates, non-linear optical materials and/or any combination thereof. As a result, the core layer 16, the wire mesh layers 18a and/or 18b, the intermediate layers 20a and/or 20b, the outer layer 24, the backing layer 26, and/or the resin layers 32a, 32b, 32c, 32d, 34a, 34b, 36a and/or 36b may also provide protection against light threats.

In several exemplary embodiments, in addition to, or instead of a polycarbonate laminate, the outer layer 24 may comprise any type of high-impact-resistant plastic sheet material, any type of transparent plastic material, any type of transparent thermoplastic material, any type of transparent thermosetting material, and/or any combination thereof. Moreover, in several exemplary embodiments, the outer layer 24 may comprise, for example, a single sheet of material, two or more sheets of material, and/or a wide variety of combinations of laminated sheets of the same or different materials.

In several exemplary embodiments, instead of comprising a thickness of 1/16 in, the thickness of the outer layer 24 may be varied. In several exemplary embodiments, the thickness of the outer layer 24 may range from about 1/16 in (or about 1.6 mm) to about ⅕ in (or about 5 mm).

In several exemplary embodiments, in addition to, or instead of a polycarbonate laminate, the backing layer 26 may comprise any type of high-impact-resistant plastic sheet material, any type of transparent plastic material, any type of transparent thermoplastic material, any type of transparent thermosetting material, and/or any combination thereof. Moreover, in several exemplary embodiments, the backing layer 26 may comprise a single sheet of material or a wide variety of combinations of laminated sheets of the same or different materials.

In several exemplary embodiments, instead of comprising a thickness of 1/16 in, the thickness of the backing layer 26 may be varied. In several exemplary embodiments, the thickness of the backing layer 26 may range from about 1/16 in (or about 1.6 mm) to about ⅕ in (or about 5 mm).

In several exemplary embodiments, in addition to, or instead of a silicone-based coating or a melamine-based coating, the coatings 28 and 30 may each comprise a wide variety of coating types that are both abrasion resistant and chemical resistant.

In several exemplary embodiments, in addition to, or instead of flow coating, the coatings 28 and 30 may be applied using other coating techniques such as, for example, dip coating and/or spin coating. Moreover, in several exemplary embodiments, in addition to, or instead of the outer side 24a and the backing side 26a, respectively, the coatings 28 and 30 may be applied to one or more other portions of the outer layer 24 and the backing layer 26, respectively.

In several exemplary embodiments, in addition to, or instead of applying the coatings 28 and 30 to the outer layer 24 and the backing layer 26, respectively, coatings that are substantially identical to the coating 28 or 30 may be applied to one or more of the other above-described layers of the laminate 14.

In several exemplary embodiments, the resin layers 32a, 32b, 32c, 32d, 34a, 34b, 36a and 36b may each comprise the same type, or different types, of transparent, bonding adhesive resin. Moreover, in several exemplary embodiments, in addition to, or instead of the resin layers 32a, 32b, 32c, 32d, 34a, 34b, 36a and 36b, the above-described layers in the laminate 14 may be coupled to one another using other types of adhesives and/or bonding techniques.

In several exemplary embodiments, in addition to, or instead of the open-faced helmet 12, the face shield 10 may be coupled to, or incorporated with, a wide variety of other types of devices including, for example, fully-enclosed head-protection gear and helmets; helmets used in military and/or combat applications; face-protection devices used in riot-control, police and law-enforcement applications; visors and helmets used in transportation applications, bomb-disposal gear and equipment; and/or any combination thereof.

In several exemplary embodiments, the shape of the laminate 14, and thus the shape of the face shield 10 and/or window 42, may be modified to accommodate other types of devices and/or applications.

In several exemplary embodiments, in addition to, or instead of the face shield 10 and/or the window 42, the laminate 14 may be used to form, and/or may be incorporated in, a wide variety of other types of transparent armor systems and/or devices, and/or components thereof, such as, for example, goggles and hand shields for civilians and/or military personnel, aircraft canopies and/or transparent armor systems for land, marine and/or aerospace-related vehicles.

In several exemplary embodiments, one or more of the above-described layers in the laminate 14 may be removed from the laminate 14. Moreover, in several exemplary embodiments, one or more sub-layers in one or more of the above-described layers in the laminate 14 may be removed from the laminate 14.

In several exemplary embodiments, one or more layers may be added to the laminate 14 for one or more reasons such as, for example, to provide extra degrees of penetration resistance, abrasion resistance, chemical resistance, shock-wave-force absorption and distribution, light-threat protection and/or any combination thereof. Moreover, in several exemplary embodiments, one or more sub-layers may be added to one or more of the above-described layers of the laminate 14 for one or more reasons such as, for example, to provide extra degrees of penetration resistance, abrasion resistance, chemical resistance, shock-wave-force absorption and distribution, light-threat protection and/or any combination thereof.

Any spatial references such as, for example, “upper,” “lower,” “above,” “below,” “between,” “vertical,” “angular,” “upward,” “downward,” “side-to-side,” “left-to-right,” “right-to-left,” “top-to-bottom,” “bottom-to-top,” etc., are for the purpose of illustration only and do not limit the specific orientation or location of the structure described above.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, any means-plus-function clauses are intended to cover the structures described herein as performing the recited function and not only structural equivalents, but also equivalent structures.

What is claimed is:

1. A transparent armor laminate, comprising:
a first layer comprising a first material having a first modulus of elasticity;
a second layer comprising a second material having a second modulus of elasticity that is less than the first modulus of elasticity; and
a third layer disposed between the first and second layers, the third layer comprising a plurality of nanotubes.

2. The laminate of claim 1 wherein the laminate has an areal density not exceeding about 3 lb/ft².

3. The laminate of claim 1 wherein at least a portion of the laminate has a thickness ranging from about 1/16 in to about ½ in.

4. The laminate of claim 1 wherein at least a portion of the layers have a rigid and a curved shape.

5. The laminate of claim 1 wherein at least a portion of the layers have a rigid and a curved shape;
wherein the laminate has an areal density not exceeding about 3 lb/ft²;
wherein at least a portion of the laminate has a thickness ranging from about 1/16 in to about ½ in; and
wherein the areal density and the thickness permit the at least a portion of the layers to have the rigid and the curved shape.

6. The laminate of claim 1 wherein the plurality of nanotubes comprises at least one of:
a plurality of carbon multi-walled nanotubes; and
a plurality of carbon single wall nanotubes.

7. The laminate of claim 1 wherein the plurality of nanotubes comprises a plurality of interlayer sheets, each sheet comprising a plurality of carbon multi-walled nanotubes.

8. The laminate of claim 7 further comprising at least one of:
an antenna integrated within the third layer; and
a sensor integrated within the third layer.

9. The laminate of claim 1 wherein the nanotubes are adapted to resist any heat transfer through the third layer.

10. The laminate of claim 1 wherein the first material is a ceramic material.

11. The laminate of claim 10 wherein the ceramic material is cubic crystal structural spinel.

12. The laminate of claim 1 wherein the second material is a polymeric material.

13. The laminate of claim 12 wherein the polymeric material is a polycarbonate laminate.

14. The laminate of claim 1 further comprising:
a wire-mesh layer disposed between the first and third layers.

15. The laminate of claim 14 wherein the wire-mesh layer comprises a plurality of wires arranged in a diamond-crossing pattern.

16. The laminate of claim 14 wherein the wire-mesh layer comprises a plurality of wires, each wire having a thickness of less than about 800 denier and comprising at least one of:
metal strengthened with carbon multi-walled nanotubes;
aramid fiber strengthened with carbon multi-walled nanotubes; and
high-modulus-polyethylene fiber strengthened with carbon multi-walled nanotubes.

17. The laminate of claim 1 further comprising:
a light filter disposed between the third and second layers.

18. The laminate of claim 1 further comprising:
an abrasion-resistant protective coating applied to the second layer.

19. The laminate of claim 1 wherein the laminate is adapted to prevent any spall produced in response to an impact on the laminate from passing either through the second layer, or through the third layer after passing through the second layer; and
wherein the impact is equal to or greater than an impact caused by a 9-mm bullet traveling at 1425 ft/sec.

20. A transparent armor laminate comprising:
a first layer comprising a first material having a first modulus of elasticity, the first material comprising cubic crystal structural spinel;
a second layer comprising a second material having a second modulus of elasticity that is less than the first modulus of elasticity, the second material comprising a polycarbonate laminate; and
a third layer disposed between the first and second layers, the third layer comprising a plurality of nanotubes, the plurality of nanotubes comprising a plurality of interlayer sheets of carbon multi-walled nanotubes;
a wire-mesh layer disposed between the first and third layers, the wire-mesh layer comprising a plurality of wires arranged in a diamond-crossing pattern, each wire in the plurality of wires comprising at least one of:
metal strengthened with carbon multi-walled nanotubes;
aramid fiber strengthened with carbon multi-walled nanotubes; and
high-modulus-polyethylene fiber strengthened with carbon multi-walled nanotubes;
a light filter disposed between the third and second layers; and
an abrasion-resistant protective coating applied to the second layer;
wherein the nanotubes are adapted to resist any heat transfer through the third layer;
wherein the laminate has an areal density not exceeding about 3 lb/ft²;
wherein at least a portion of the laminate has a thickness ranging from about ⅕ in to about ½ in;
wherein the laminate is adapted to prevent any spall produced in response to an impact on the laminate from passing either through the second layer, or through the third layer after passing through the second layer; and
wherein the impact is equal to or greater than an impact caused by a 9-mm bullet traveling at 1425 ft/sec.

21. A method of producing a transparent armor laminate, comprising:
providing a first layer comprising a first material having a first modulus of elasticity;
providing a second layer comprising a second material having a second modulus of elasticity that is less than the first modulus of elasticity; and
disposing a third layer between the first and second layers, the third layer comprising a plurality of nanotubes.

22. The method of claim 1 wherein the laminate has an areal density not exceeding about 3 lb/ft².

23. The method of claim 21 wherein at least a portion of the laminate has a thickness ranging from about 1/16 in to about ½ in.

24. The method of claim 21 wherein at least a portion of the layers have a rigid and a curved shape.

25. The method of claim 21 wherein at least a portion of the layers have a rigid and a curved shape;
wherein the laminate has an areal density not exceeding about 3 lb/ft²;
wherein at least a portion of the laminate has a thickness ranging from about 1/16 in to about ½ in; and
wherein the areal density and the thickness permit the at least a portion of the layers to have the rigid and the curved shape.

26. The method of claim 21 wherein the plurality of nanotubes comprises at least one of:
a plurality of carbon multi-walled nanotubes; and
a plurality of carbon single wall nanotubes.

27. The method of claim 21 wherein the plurality of nanotubes comprises a plurality of interlayer sheets, each sheet comprising a plurality of carbon multi-walled nanotubes.

28. The method of claim 27 further comprising at least one of:
integrating an antenna within the third layer; and
integrating a sensor within the third layer.

29. The method of claim 21 wherein the nanotubes are adapted to resist any heat transfer through the third layer.

30. The method of claim 21 wherein the first material is a ceramic material.

31. The method of claim 30 wherein the ceramic material is cubic crystal structural spinel.

32. The method of claim 21 wherein the second material is a polymeric material.

33. The method of claim 32 wherein the polymeric material is a polycarbonate laminate.

34. The method of claim 21 further comprising:
disposing a wire-mesh layer between the first and third layers.

35. The method of claim 34 wherein the wire-mesh layer comprises a plurality of wires arranged in a diamond-crossing pattern.

36. The method of claim 34 wherein the wire-mesh layer comprises a plurality of wires, each wire having a thickness of less than about 800 denier and comprising at least one of:
metal strengthened with carbon multi-walled nanotubes;
aramid fiber strengthened with carbon multi-walled nanotubes; and
high-modulus-polyethylene fiber strengthened with carbon multi-walled nanotubes.

37. The method of claim 21 further comprising:
disposing a light filter between the third and second layers.

38. The method of claim 21 further comprising:
applying an abrasion-resistant protective coating to the second layer.

39. The method of claim 21 wherein the laminate is adapted to prevent any spall produced in response to an impact on the laminate from passing either through the second layer, or through the third layer after passing through the second layer; and
wherein the impact is equal to or greater than an impact caused by a 9-mm bullet traveling at 1425 ft/sec.

40. A method of producing a transparent armor laminate, comprising:
providing a first layer comprising a first material having a first modulus of elasticity, the first material comprising cubic crystal structural spinel;
providing a second layer comprising a second material having a second modulus of elasticity that is less than the first modulus of elasticity, the second material comprising a polycarbonate laminate; and
disposing a third layer between the first and second layers, the third layer comprising a plurality of nanotubes, the plurality of nanotubes comprising a plurality of interlayer sheets of carbon multi-walled nanotubes;
disposing a wire-mesh layer between the first and third layers, the wire-mesh layer comprising a plurality of wires arranged in a diamond-crossing pattern, each wire in the plurality of wires comprising at least one of:
metal strengthened with carbon multi-walled nanotubes;
aramid fiber strengthened with carbon multi-walled nanotubes; and
high-modulus-polyethylene fiber strengthened with carbon multi-walled nanotubes;
disposing a light filter between the third and second layers; and
applying an abrasion-resistant protective coating to the second layer;
wherein the carbon multi-walled nanotubes are adapted to resist any heat transfer through the third layer;
wherein the laminate has an areal density not exceeding about 3 lb/ft²;
wherein the at least a portion of the laminate has a thickness ranging from about ⅕ in to about ½ in;
wherein the laminate is adapted to prevent any spall produced in response to an impact on the laminate from passing either through the second layer, or through the third layer after passing through the second layer; and
wherein the impact is equal to or greater than an impact caused by a 9-mm bullet traveling at 1425 ft/sec.

41. A method comprising:
absorbing and distributing shock waves in at least one layer of material in response to at least one other layer of material being impacted; and
providing nanotubes in the at least one layer of material.

42. The method of claim 41 wherein the at least one layer of material and the at least one other layer of material are part of a transparent laminate.

43. The method of claim 41 wherein any spall produced in response to the impact does not pass through the at least one layer.

44. The method of claim 41 wherein any spall produced in response to the impact does not pass through a third layer of material after passing through the at least one layer;
wherein the at least one layer of material is disposed between the at least one other layer of material and the third layer of material; and
wherein the at least one layer of material, the at least one other layer of material and the third layer of material are part of a transparent laminate.

45. The method of claim 41 further comprising:
resisting any heat transfer through the at least one layer of material using the nanotubes.

46. The method of claim 41 further comprising at least one of:
integrating an antenna within the at least one layer of material; and
integrating a sensor within the at least one layer of material.

47. The method of claim 41 wherein the impact is equal to or greater than an impact caused by a 9-mm bullet traveling at 1425 ft/sec.

48. The method of claim 41 further comprising:
absorbing and distributing shock waves in a wire-mesh layer in response to the at least one other layer of material being impacted;
wherein the wire-mesh layer is disposed between the at least one other layer of material and the at least one layer of material; and
wherein the at least one layer of material, the at least one other layer of material and the wire-mesh layer are part of a transparent laminate.
